(19) United States
(12) Patent Application Publication
(10) Pub. No.: US 2024/0402742 A1
(43) Pub. Date: Dec. 5, 2024

(54) Constant Current Control Circuit, Driver Chip and Electronic Equipment

(71) Applicant: InventChip Technology Co.,Ltd., Shanghai (CN)

(72) Inventors: Zhong Ye, Plano, TX (US); Danyang Zhu, Cary, NC (US); Hailong Yang, Shanghai (CN)

(21) Appl. No.: 18/806,655

(22) Filed: Aug. 15, 2024

Related U.S. Application Data
(63) Continuation of application No. PCT/CN2023/133288, filed on Nov. 22, 2023.

(30) Foreign Application Priority Data
Mar. 30, 2023 (CN) CN202310334232A

(51) Int. Cl. G05F 1/565

(52) U.S. Cl. CPC G05F 1/565

(57) ABSTRACT

A constant current control circuit includes a voltage detection unit, an amplification unit, and a constant current control unit. The voltage detection unit is connected to the gate of the driven transistor, the negative input terminal of the amplification unit, and the current output terminal of the constant current control unit. The positive input terminal of the amplification unit is used to receive an amplification reference voltage. The voltage detection unit is used to obtain a detection voltage based on the drive current output to the gate of the driven transistor. The amplification unit is used to amplify the difference between the amplification reference voltage and the detection voltage, outputting an amplified signal. The constant current control unit is connected to the amplification unit and is used to adjust the drive current based on the amplified signal to achieve constant current driving of the driven transistor.

### CROSS-REFERENCE TO RELATED APPLICATIONS

This application is a continuation application of International Application No. PCT/CN2023/133288, filed on Nov. 22, 2023, which claims priority to Chinese Patent Application No. CN202310334232A, filed on Mar. 30, 2023. The disclosures of the aforementioned applications are hereby incorporated herein by reference in their entireties.

### TECHNICAL FIELD

This disclosure relates to the field of integrated circuit technology, specifically to a constant current control circuit, a driver chip, and electronic equipment.

### BACKGROUND

Currently, all semiconductor power devices in the market need to be driven by a driving circuit. The switching speed of the semiconductor power devices is determined by the drive current of the driving circuit. However, the majority of current drives are constant voltage drives, which results in different dV/dT (voltage change rate) under different loads. The variation in dV/dT makes it difficult to control electromagnetic interference (EMI).

### SUMMARY

Technical advantages are generally achieved, by embodiments of this disclosure which describe a constant current control circuit, a driver chip, and electronic equipment.

According to one aspect of this disclosure, a constant current control circuit is provided. The constant current control circuit comprises a voltage detection unit, an amplification unit, and a constant current control unit.

The first terminal of the voltage detection unit is connected to the gate of the driven transistor, while the second terminal is connected to the inverting input of the amplification unit and the current output of the constant current control unit. The non-inverting input of the amplification unit is used to receive the amplification reference voltage. The voltage detection unit is used to obtain the detection voltage based on the drive current supplied to the gate of the driven transistor. The amplification unit amplifies the difference between the amplification reference voltage and the detection voltage, and outputs an amplified signal. The constant current control unit connected to the amplification unit is configured to adjust the drive current based on the amplified signal to achieve constant current driving of the driven transistor.

In one possible embodiment, the voltage detection unit includes a first diode, a first resistor, and a second resistor. The anode of the first diode is connected to the first terminal of the second resistor, the inverting input of the amplification unit, and the current output of the constant current control unit. The cathode of the first diode is connected to the first terminal of the first resistor. Both the second terminal of the first resistor and the second terminal of the second resistor are connected to the gate of the driven transistor.

In another possible embodiment, the constant current control unit includes a constant current control logic circuit, a current mirror, and a third transistor. The constant current control logic circuit is connected to the output of the amplification unit, the first terminal of the current mirror, and the gate of the third transistor. The constant current control logic circuit generates a control current based on the amplified signal and feeds the control current into the first terminal of the current mirror. The second terminal of the current mirror outputs a mirrored current of the control current. The second terminal of the current mirror is connected to the drain of the third transistor and the second terminal of the voltage detection unit. The source of the third transistor is grounded. The constant current control logic circuit is also used for controlling the third transistor to be switched on or switched off based on the control signal.

In yet another possible embodiment, the constant current control logic circuit includes an NOR gate, a buffer, a NOT gate, an OR gate, a second diode, and a third resistor. The current mirror includes a fourth transistor and a fifth transistor. The first input of the NOR gate and the input of the NOT gate are used to receive the control signal. The second input of the NOR gate is connected to the first input of the OR gate. The output of the NOR gate is connected to the input of the buffer, whose output is connected to the gate of the third transistor. The output of the NOT gate is connected to the second input of the OR gate. The output of the OR gate is connected to the anode of the second diode. The first terminal of the third resistor is connected to the output of the amplification unit. The collector of the fourth transistor is connected to the base of the fourth transistor, the gate of the fifth transistor, the cathode of the second diode, and the second terminal of the third resistor to receive the control current. The emitters of both the fourth and fifth transistors are used to receive the supply voltage VDD. The collector of the fifth transistor is connected to the drain of the third transistor, the inverting input of the amplification unit, the anode of the first diode, and the first terminal of the second resistor.

In another possible embodiment, the constant current control circuit also includes a Miller clamp unit for clamping the driven transistor. The Miller clamp unit comprises a second transistor and a comparator. The drain of the second transistor is connected to the non-inverting input of the comparator and the gate of the driven transistor. The source of the second transistor is grounded, and its gate receives the Miller control voltage. The inverting input of the comparator receives a comparison threshold voltage. The output of the comparator outputs the comparison result.

In another possible embodiment, the constant current control circuit further includes a control component connected to the constant current control unit to control the constant current driving of the driven transistor.

According to one aspect of this disclosure, a driver chip is provided, which includes the constant current control circuit described above.

According to one aspect of this disclosure, an electronic device is provided, which includes the driver chip described above. In one possible embodiment, the electronic device includes any one of a display, a smartphone, a smart watch, a smart bracelet, a tablet, a laptop, an all-in-one computer, an access control device, and an electronic door lock.

In the embodiment of this disclosure, the voltage detection unit obtains the detection voltage based on the drive current output to the gate of the driven transistor. The amplification unit amplifies the difference between the amplification reference voltage and the detection voltage, and outputs an amplified signal. The constant current control unit adjusts the drive current based on the amplified signal to achieve constant current driving of the driven transistor. This ensures a relatively constant voltage change rate when the transistor is turned on under different loads, facilitating EMI control.

It should be understood that the above general description and the detailed description that follows are merely exemplary and explanatory and are not restrictive of this disclosure. Other features and aspects of the present disclosure will become apparent from the detailed description of exemplary embodiments with reference to the accompanying drawings.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

The accompanying drawings are incorporated herein and constitute a part of this specification. These drawings illustrate embodiments in accordance with this disclosure and, together with the description, serve to explain the technical solutions of this disclosure.

FIG. 1 shows a schematic diagram of the constant current control circuit according to an embodiment of this disclosure;

FIG. 2 shows a schematic diagram of the constant current control circuit according to another embodiment of this disclosure; and

FIG. 3 shows a schematic diagram of the constant current control circuit according to yet another embodiment of this disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The following will provide a detailed description of various exemplary embodiments, features, and aspects of this disclosure with reference to the accompanying drawings. Identical reference numerals in the drawings indicate elements with the same or similar functions. Although various aspects of the embodiments are shown in the drawings, they are not necessarily drawn to scale unless specifically noted.

In the description of this disclosure, it should be understood that terms “length,” “width,” “top,” “bottom,” “front,” “back,” “left,” “right,” “vertical,” “horizontal,” “upper,” “lower,” “inner,” “outer,” and the like indicate orientations or positional relationships based on the orientations or positional relationships shown in the drawings. These terms are for the convenience of describing this disclosure and simplifying the description and are not intended to indicate or imply that the referenced device or element must have a specific orientation, be constructed, and operate in a specific orientation. Therefore, they should not be construed as limitations on this disclosure.

Furthermore, terms like “first” and “second” are only used for descriptive purposes and should not be understood as indicating or implying relative importance or implicitly indicating the number of the specified technical features. Thus, features defined as “first” and “second” may explicitly or implicitly include one or more of such features. In the description of this disclosure, the term “multiple” means two or more unless otherwise specified.

In this disclosure, unless otherwise expressly specified and limited, terms such as “installed,” “connected,” “joined,” and “fixed” should be interpreted broadly. For example, they may refer to fixed connections, removable connections, or integral connections; they may refer to mechanical connections or electrical connections; they may refer to direct connections or indirect connections through an intermediary; and they may refer to internal communication between two elements or interaction between two elements. For those skilled in the art, the specific meanings of these terms in this disclosure can be understood based on specific circumstances.

The term “exemplary” means “serving as an example, embodiment, or illustration.” Any embodiment described as “exemplary” should not be construed as preferred or more favorable than other embodiments.

The term “and/or” is used to describe the association between associated objects, indicating three kinds of relationships. For example, “A and/or B” can mean: A alone, A and B together, or B alone. Additionally, the term “at least one” means any one or more of the multiple elements. For instance, “including at least one of A, B, and C” means including any one or more of A, B, and C.

To better illustrate this disclosure, numerous specific details are set forth in the following specific embodiments. However, those skilled in the art should understand that this disclosure may be implemented without some specific details. In some instances, well-known methods, means, elements, and circuits are not described in detail to highlight the gist of this disclosure.

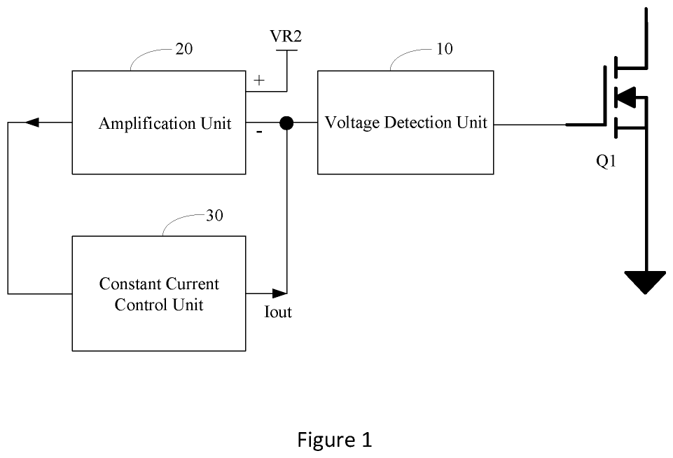

Refer to FIG. 1. FIG. 1 shows a schematic diagram of a constant current control circuit according to an embodiment of this disclosure.

As shown in FIG. 1, the constant current control circuit includes a voltage detection unit 10, an amplification unit 20, and a constant current control unit 30.

The first terminal of the voltage detection unit 10 is connected to the gate of the driven transistor Q1. The second terminal of the voltage detection unit 10 is connected to the inverting input of the amplification unit 20 and the current output terminal of the constant current control unit 30. The non-inverting input of the amplification unit 20 is used to receive the amplification reference voltage VR2. The voltage detection unit 10 is used to obtain a detection voltage based on the drive current Iout output to the gate of the driven transistor Q1. The amplification unit 20 amplifies the difference between the reference voltage VR2 and the detection voltage and outputs an amplified signal.

The constant current control unit 30 is connected to the amplification unit 20 and adjusts the drive current Iout according to the amplified signal to achieve constant current driving of the driven transistor Q1.

In this disclosure's embodiment, the voltage detection unit 10 obtains a detection voltage based on the drive current Iout supplied to the gate of the driven transistor Q1. The amplification unit 20 amplifies the difference between the amplification reference voltage VR2 and the detection voltage and generates an amplified signal. The constant current control unit 30 adjusts the drive current Iout according to the amplified signal to achieve constant current driving of the driven transistor Q1. This ensures a relatively constant voltage change rate when the transistor is conducting under different loads, facilitating EMI control.

Furthermore, compared with a complex circuit in the related art, the constant current control circuit disclosed by the embodiment of the invention has a simple structure and lower cost, and is convenient to popularize and use the constant current control circuit in this embodiment is, making it easier to promote and use.

For example, the amplification unit 20 may include an error amplifier. After the amplification unit 20 amplifies the difference between the reference voltage VR2 and the detection voltage and generates the amplified signal, the constant current control unit 30 can generate a control current according to the amplified signal, thereby adjusting the drive current.

This disclosure does not limit the specific implementation of the voltage detection unit 10, the amplification unit 20, and the constant current control unit 30. Those skilled in the art can choose suitable technical means based on actual conditions and needs. The following provides an exemplary introduction to possible implementations of the voltage detection unit 10, the amplification unit 20, and the constant current control unit 30.

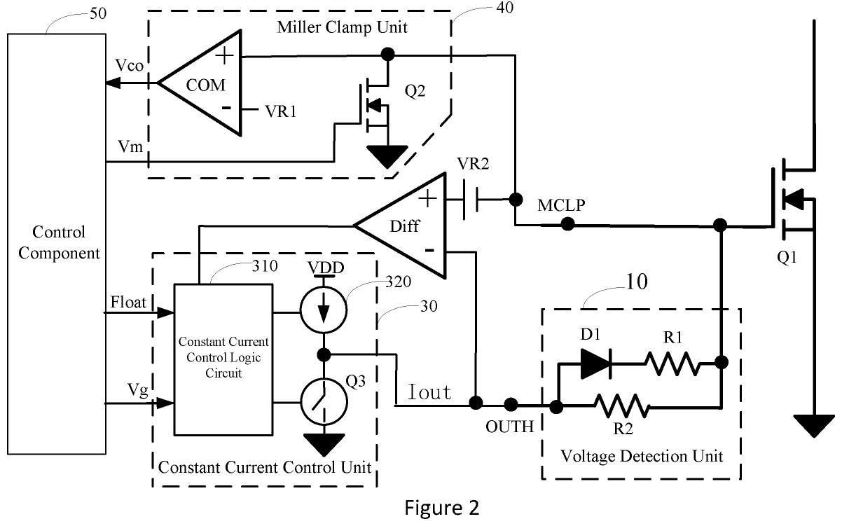

Refer to FIG. 2. FIG. 2 shows a schematic diagram of the constant current control circuit according to another embodiment of this disclosure.

In a possible implementation, as shown in FIG. 2, the voltage detection unit 10 may include a first diode D1, a first resistor R1, and a second resistor R2.

The anode of the first diode D1 is connected to the first terminal of the second resistor R2, the inverting input of the amplification unit 20, and the current output terminal of the constant current control unit 30.

The cathode of the first diode D1 is connected to the first terminal of the first resistor R1. The second terminal of the first resistor R1 and the second terminal of the second resistor R2 are both connected to the gate of the driven transistor Q1.

This disclosure does not limit the device parameters and types of the first diode D1, the first resistor R1, and the second resistor R2. Those skilled in the art can select a suitable device according to actual situations and needs to apply the device to the constant current control circuit in the embodiment of the disclosure. This embodiment uses the first resistor R1 and the second resistor R2 in the driving circuit to perform current detection, so that the detection efficiency can be improved, the detection cost can be reduced, other complex detection circuits are not required to be arranged, and complex detection logic is not required to be arranged.

In a possible implementation, as shown in FIG. 2, the constant current control unit 30 may include a constant current control logic circuit 310, a current mirror 320, and a third transistor Q3.

The constant current control logic circuit 310 is connected to the output terminal of the amplification unit 20, the first terminal of the current mirror 320, and the gate of the third transistor Q3. The constant current control logic circuit 310 generates a control current based on the amplified signal. The constant current control logic circuit 310 feeds the control current into the first terminal of the current mirror 320. The second terminal of the current mirror 320 outputs the mirrored current of the control current.

The second terminal of the current mirror 320 is connected to the drain of the third transistor Q3 and the second terminal of the voltage detection unit 10. The source of the third transistor Q3 is grounded.

The constant current control logic circuit 310 also controls the third transistor Q3 to be turned on or off according to the control signal.

In this embodiment, the constant current control logic circuit 310 generates the control current based on the amplified signal and feeds the control current into the first terminal of the current mirror 320. The current mirror 320 outputs the mirrored current of the control current to the driven transistor Q1 so that the driving current Iout can be adaptively adjusted, thereby achieving constant current driving of the driven transistor Q1. Moreover, through the control of the third transistor Q3, this embodiment can easily control the operating state of the drive circuit. For example, when constant current driving of the driven transistor Q1 is needed, the third transistor Q3 can be turned off by a control signal. The constant current control unit 30 outputs the drive current Iout to drive the driven transistor Q1, and the drive current Iout is adaptively adjusted through the cooperation of the voltage detection unit 10, the amplification unit 20, and the constant current control unit 30 to achieve constant current driving of the driven transistor Q1. For example, when the driven transistor Q1 needs to be turned off, the third transistor Q3 can be turned on by a control signal, and thus the driven transistor Q1 is turned off by being pulled down by the second resistor R2.

This disclosure does not limit the specific implementation of the constant current control logic circuit 310 and the current mirror 320. A person skilled in the art may select a suitable technical means to implement according to actual situations and needs. The following provides an exemplary introduction to possible implementations of the constant current control logic circuit 310 and the current mirror 320.

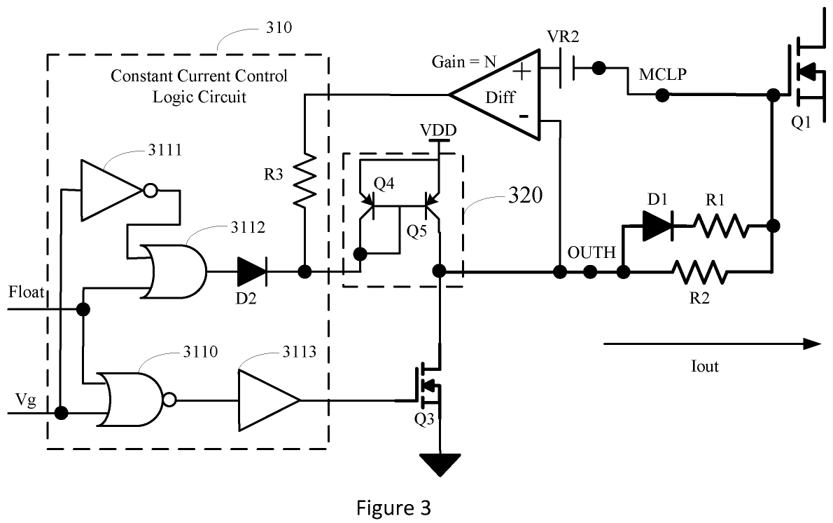

Refer to FIG. 3. FIG. 3 shows a schematic diagram of the constant current control circuit according to yet another embodiment of this disclosure.

In a possible implementation, as shown in FIG. 3, the constant current control logic circuit 310 may include an NOR gate 3110, a buffer 3113, an NOT gate 3111, an OR gate 3112, a second diode D2, and a third resistor R3. The current mirror 320 may include a fourth transistor Q4 and a fifth transistor Q5.

The first input terminal of the NOR gate 3110 and the input terminal of the NOT gate 3111 are used to receive the control signal.

The second input terminal of the NOR gate 3110 is connected to the first input terminal of the OR gate 3112.

The output terminal of the NOR gate 3110 is connected to the input terminal of the buffer 3113, and the output terminal of the buffer 3113 is connected to the gate of the third transistor Q3.

The output terminal of the NOT gate 3111 is connected to the second input terminal of the OR gate 3112.

The output terminal of the OR gate 3112 is connected to the anode of the second diode D2. The first terminal of the third resistor R3 is connected to the output terminal of the amplification unit 20.

The collector of the fourth transistor Q4 is connected to the base of the fourth transistor Q4, the base of the fifth transistor Q5, the cathode of the second diode D2, and the second terminal of the third resistor R3. The collector of the fourth transistor Q4 is used to receive the control current.

The emitter of the fourth transistor Q4 and the emitter of the fifth transistor Q5 are connected to the power supply voltage VDD.

The collector of the fifth transistor Q5 is connected to the drain of the third transistor Q3, the inverting input of the amplification unit 20, the anode of the first diode D1, and the first terminal of the second resistor R2.

Exemplarily, the second input terminal of the NOR gate 3110 and the first input terminal of the OR gate 3112 can be set to float (no connection).

Exemplarily, as shown in FIG. 3, if the third transistor Q3 is a PMOS transistor, when the input signal Vg is high, the NOR gate 3110 outputs a high level, and accordingly, the buffer 3113 also outputs a high level, turning off the third transistor Q3. The constant current circuit generates a drive current Iout to drive the driven transistor Q1. As shown in FIG. 3, the method of achieving constant current control is as follows: when the third transistor Q3 is turned off and a drive current Iout is generated, a detection voltage is generated across the first resistor R1 and the second resistor R2 connected in parallel. When the detection voltage is lower than the amplification reference voltage VR2, the constant current control logic circuit 310 increases the output of the drive current Iout until the voltage difference between the MCLP node and the OUTH node (i.e., the two input terminals of the error amplifier Diff) reaches the amplification reference voltage VR2 and enters a balanced state, with the output being the set current, thereby achieving constant current driving.

Exemplarily, the following provides an application example of the drive current Iout and the off-resistor:

Assume the power supply voltage VDD=20V and the amplification reference voltage VR2=2V. If the resistance Roff of the second resistor R2 is 2 ohms, then the maximum off current=20V/2 ohms=10 A. If the drive current Iout is to be set at 5 A, since the amplification reference voltage VR2 is also applied across the second resistor R2, the generated current is 2V/2 ohms=1 A. Therefore, the current flowing through the first resistor R1 is 5 A-1 A=4 A. If the voltage drop of the first diode D1 is 0.4V, the resistance Ron of the first resistor R1 is (2V−0.4V)/4 A=0.4 ohms.

In a possible implementation, as shown in FIG. 2, the circuit may further include a Miller clamp unit 40 for performing Miller clamping on the driven transistor Q1. The Miller clamp unit 40 includes a second transistor Q2 and a comparator COM. The drain of the second transistor Q2 is connected to the non-inverting input of the comparator COM and the gate of the driven transistor Q1. The source of the second transistor Q2 is grounded. The gate of the second transistor Q2 is used to receive the Miller control voltage Vm. The inverting input of the comparator COM is used to receive the comparison threshold voltage VR1. The output terminal of the comparator COM is used to generate the comparison result Vco.

Exemplarily, as shown in FIG. 2, the constant current control unit 30 and the Miller clamp unit 40 of the embodiment of this disclosure share one pin (MCLP). The embodiment of this disclosure can use pin multiplexing through pin sharing, thereby reducing the pin usage of the driver chip. Compared with the solution in related technologies that sets additional detection and driving, and uses additional pins, the embodiment of this disclosure can reduce costs and improve pin utilization efficiency.

In a possible implementation, the constant current control circuit may further include a control component 50 connected to the constant current control unit 30 for controlling the constant current control unit 30 to perform constant current driving on the driven transistor Q1.

This disclosure does not limit the specific implementation of the control component 50. Those skilled in the art can choose suitable technical means based on actual conditions and needs. Exemplarily, the control component 50 may include a processing component. In one example, the processing component includes but is not limited to a separate processor, discrete components, or a combination of a processor and discrete components. The processor may include a controller in an electronic device with the function of executing instructions. The processor can be implemented in any suitable way, such as being implemented by one or more application-specific integrated circuits (ASIC), digital signal processors (DSP), digital signal processing devices (DSPD), programmable logic devices (PLD), field-programmable gate arrays (FPGA), controllers, microcontrollers, microprocessors, or other electronic components. Inside the processor, the executable instructions can be executed through hardware circuits such as logic gates, switches, ASICs, programmable logic controllers, and embedded microcontrollers.

According to one aspect of this disclosure, a driver chip is provided, which includes the aforementioned constant current control circuit.

According to another aspect of this disclosure, an electronic device is provided, which includes the aforementioned driver chip.

In a possible implementation, the electronic device may include any one of a display, a smartphone, a smartwatch, a smart wristband, a tablet, a laptop, an all-in-one computer, an access control device, and an electronic door lock.

Of course, the electronic device can also be other terminal devices, which may be user equipment (UE), mobile devices, user terminals, handheld devices, computing devices, or in-vehicle devices. Exemplarily, examples of some terminals include: mobile phones, tablets, laptops, PDAs, mobile internet devices (MID), wearable devices, virtual reality (VR) devices, augmented reality (AR) devices, wireless terminals in industrial control, wireless terminals in self-driving, wireless terminals in remote medical surgery, wireless terminals in smart grids, wireless terminals in transportation safety, wireless terminals in smart cities, wireless terminals in smart homes, and wireless terminals in the Internet of Vehicles. For example, the server can be a local server or a cloud server.

The various embodiments of this disclosure have been described above. The foregoing description is exemplary and not exhaustive and is not limited to the disclosed embodiments. Many modifications and variations are apparent to those skilled in the art without departing from the scope and spirit of the described embodiments. The choice of terms herein aims to best explain the principles and practical applications or improvements to the technology in the market, or to enable other skilled artisans to understand the embodiments disclosed herein.

What is claimed is:

1. A constant current control circuit comprising:
a voltage detection unit connected between a gate of a driven transistor and an amplification unit, wherein the voltage detection unit is configured to obtain a detection voltage based on a drive current supplied to the gate of the driven transistor;
the amplification unit configured to amplify a difference between an amplification reference voltage and the detection voltage, and generate an amplified signal; and
a constant current control unit connected to the amplification unit, wherein the constant current control unit is configured to adjust the drive current based on the amplified signal to achieve constant current driving of the driven transistor.

2. The constant current control circuit of claim 1, wherein:
the voltage detection unit comprises a first diode, a first resistor, and a second resistor.

3. The constant current control circuit of claim 2, wherein:
an anode of the first diode is connected to a first terminal of the second resistor;
a cathode of the first diode is connected to a first terminal of the first resistor; and
a second terminal of the first resistor and a second terminal of the second resistor are connected together and further connected to the gate of the driven transistor, and wherein:
a common node of the first diode and the second resistor is a second terminal of the voltage detection unit; and
a common node of the first resistor and the second resistor is a first terminal of the voltage detection unit.

4. The constant current control circuit of claim 3, wherein:
an inverting input of the amplification unit is connected to the second terminal of the voltage detection unit;
a non-inverting input of the amplification unit is connected to the first terminal of the voltage detection unit through a reference voltage source;
an output of the constant current control unit is connected to the second terminal of the voltage detection unit; and
the gate of the driven transistor is connected to the first terminal of the voltage detection unit.

5. The constant current control circuit of claim 1, wherein:
the amplification unit comprises an amplifier and an amplification reference voltage source, and wherein:
a positive terminal of the amplification reference voltage source is connected to a non-inverting input of the amplifier;
a negative terminal of the amplification reference voltage source is connected to the gate of the driven transistor;
an inverting input of the amplifier is connected to a common node of the voltage detection unit and the constant current control unit; and
an output of the amplifier is configured to generate the amplified signal fed into the constant current control unit.

6. The constant current control circuit of claim 1, wherein:
the constant current control unit comprises a constant current control logic circuit, a current mirror and a third transistor, and wherein the current mirror and the third transistor are connected in series between a bias voltage and ground.

7. The constant current control circuit of claim 6, wherein:
the constant current control logic circuit is configured to receive the amplified signal, generate a control current based on the amplified signal, and feed the control current into a first terminal of the current mirror; and
a second terminal of the current mirror is configured to generate a mirrored current of the control current.

8. The constant current control circuit of claim 6, wherein:
the constant current control logic circuit comprises an NOR gate, a buffer, a NOT gate, an OR gate, a second diode, and a third resistor; and
the current mirror comprises a fourth transistor and a fifth transistor.

9. The constant current control circuit of claim 8, wherein:
a first input terminal of the NOR gate and an input terminal of the NOT gate are configured to receive a control signal;
a second input terminal of the NOR gate is connected to a first input terminal of the OR gate;
an output terminal of the NOR gate is connected to an input terminal of the buffer;
an output terminal of the buffer is connected to a gate of the third transistor;
an output terminal of the NOT gate is connected to a second input terminal of the OR gate;
an output terminal of the OR gate is connected to an anode of the second diode;
a first terminal of the third resistor is connected to an output terminal of the amplification unit;
a collector of the fourth transistor is connected to a base of the fourth transistor, a base of the fifth transistor, a cathode of the second diode, and a second terminal of the third resistor to receive a control current generated by the constant current control logic circuit;
an emitter of the fourth transistor and an emitter of the fifth transistor are used to receive a power supply voltage; and
a collector of the fifth transistor is connected to a drain of the third transistor, an inverting input terminal of the amplification unit, an anode of the first diode, and a first terminal of the second resistor.

10. The constant current control circuit of claim 1, further comprising:
a Miller clamp unit used to perform Miller clamping on the driven transistor, wherein the Miller clamp unit comprises a second transistor and a comparator, and wherein:
a drain of the second transistor is connected to a non-inverting input of the comparator and the gate of the driven transistor;
a source of the second transistor is grounded;
a gate of the second transistor is configured to receive a Miller control voltage;
an inverting input of the comparator is configured to receive a comparison threshold voltage; and
an output terminal of the comparator is configured to generate a comparison result.

11. The constant current control circuit of claim 1, further comprising:
a control component, wherein the control component unit comprises a processor configured to control the constant current control unit to perform constant current driving on the driven transistor.

12. A method comprising:
detecting a voltage across a resistor, wherein the voltage is proportional to a drive current supplied to a gate of a driven transistor;
amplifying a difference between an amplification reference voltage and the voltage to generate an amplified signal; and
adjusting the drive current based on the amplified signal to achieve constant current driving of the driven transistor.

13. The method of claim 12, further comprising:
detecting the voltage across the resistor using a voltage detection unit, wherein the voltage detection unit comprises a first diode and a first resistor connected in series and further connected in parallel with a second resistor, and wherein the second resistor is the resistor.

14. The method of claim 12, further comprising:
amplifying the difference between the amplification reference voltage and the voltage to generate the amplified signal using an amplification unit, wherein:
an inverting input of the amplification unit is connected to a second terminal of the voltage detection unit; and
a non-inverting input of the amplification unit is connected to a first terminal of the voltage detection unit through a reference voltage source.

15. The method of claim 12, further comprising:
adjusting the drive current based on the amplified signal using a constant current control unit, wherein the amplified signal is generated by an amplification unit based on the difference between the amplification reference voltage and the voltage generated by a voltage detection unit.

16. The method of claim 15, wherein:
the constant current control unit comprises a constant current control logic circuit, a current mirror and a third transistor, and wherein the constant current control logic circuit comprises an NOR gate, a buffer, a NOT gate, an OR gate, a second diode, and a third resistor, and the current mirror comprises a fourth transistor and a fifth transistor, and wherein:
a first input terminal of the NOR gate and an input terminal of the NOT gate are configured to receive a control signal;
a second input terminal of the NOR gate is connected to a first input terminal of the OR gate;
an output terminal of the NOR gate is connected to an input terminal of the buffer;
an output terminal of the buffer is connected to a gate of the third transistor;
an output terminal of the NOT gate is connected to a second input terminal of the OR gate;
an output terminal of the OR gate is connected to an anode of the second diode;
a first terminal of the third resistor is connected to an output terminal of the amplification unit;
a collector of the fourth transistor is connected to a base of the fourth transistor, a base of the fifth transistor, a cathode of the second diode, and a second terminal of the third resistor to receive a control current generated by the constant current control logic circuit;
an emitter of the fourth transistor and an emitter of the fifth transistor are used to receive a power supply voltage; and
a collector of the fifth transistor is connected to a drain of the third transistor, an inverting input terminal of the amplification unit, an anode of a first diode in the voltage detection unit, and a first terminal of a second resistor in the voltage detection unit.

17. A system comprising:
a voltage detection unit connected between a gate of a driven transistor and an amplification unit, wherein the voltage detection unit is configured to obtain a detection voltage based on a drive current supplied to the gate of the driven transistor;
the amplification unit configured to amplify a difference between an amplification reference voltage and the detection voltage, and generate an amplified signal;
a constant current control unit connected to the amplification unit, wherein the constant current control unit is configured to adjust the drive current based on the amplified signal to achieve constant current driving of the driven transistor;
a Miller clamp unit; and
a control component unit coupled to the Miller clamp unit and the constant current control unit.

18. The system of claim 17, wherein:
the control component unit comprises a processor configured to control the constant current control unit to perform constant current driving on the driven transistor; and
the Miller clamp unit is configured to perform Miller clamping on the driven transistor, wherein the Miller clamp unit comprises a second transistor and a comparator, and wherein:
a drain of the second transistor is connected to a non-inverting input of the comparator and the gate of the driven transistor;
a source of the second transistor is grounded;
a gate of the second transistor is configured to receive a Miller control voltage generated by the control component unit;
an inverting input of the comparator is configured to receive a comparison threshold voltage; and
an output terminal of the comparator is configured to generate a comparison result fed into the control component unit.

19. The system of claim 17, wherein:
the voltage detection unit comprises a first diode, a first resistor, and a second resistor, and wherein:
an anode of the first diode is connected to a first terminal of the second resistor;
a cathode of the first diode is connected to a first terminal of the first resistor; and
a second terminal of the first resistor and a second terminal of the second resistor are connected together and further connected to the gate of the driven transistor.

20. The system of claim 17, wherein:
the constant current control unit comprises a constant current control logic circuit, a current mirror and a third transistor, and wherein the constant current control logic circuit comprises an NOR gate, a buffer, a NOT gate, an OR gate, a second diode, and a third resistor, and the current mirror comprises a fourth transistor and a fifth transistor, and wherein:
a first input terminal of the NOR gate and an input terminal of the NOT gate are configured to receive a control signal;
a second input terminal of the NOR gate is connected to a first input terminal of the OR gate;
an output terminal of the NOR gate is connected to an input terminal of the buffer;
an output terminal of the buffer is connected to a gate of the third transistor;
an output terminal of the NOT gate is connected to a second input terminal of the OR gate;
an output terminal of the OR gate is connected to an anode of the second diode;
a first terminal of the third resistor is connected to an output terminal of the amplification unit;
a collector of the fourth transistor is connected to a base of the fourth transistor, a base of the fifth transistor, a cathode of the second diode, and a second terminal of the third resistor to receive a control current generated by the constant current control logic circuit;
an emitter of the fourth transistor and an emitter of the fifth transistor are used to receive a power supply voltage; and
a collector of the fifth transistor is connected to a drain of the third transistor, an inverting input terminal of the amplification unit, an anode of a first diode in the voltage detection unit, and a first terminal of a second resistor in the voltage detection unit.
